(19) United States
(12) Patent Application Publication
(10) Pub. No.: US 2018/0223124 A1
(43) Pub. Date: Aug. 9, 2018

(54) COLLOIDAL (METH)ACRYLIC POLYMER EMULSION AND WATER-BASED HOT STAMPING PRIMER COATING

(71) Applicant: BASF SE, Ludwigshafen (DE)

(72) Inventors: Ping YAN, Shanghai (CN); Jianfeng XIA, Shanghai (CN); Chunying LIU, Shanghai (CN)

(21) Appl. No.: 15/750,412

(22) PCT Filed: Aug. 4, 2016
(86) PCT No.: PCT/IB2016/054723

§ 371 Date: Feb. 5, 2018

(30) Foreign Application Priority Data
Aug. 6, 2015 (CN) PCT/CN2015/086227

(51) Int. Cl. C09D 133/12; C09D 5/00; C09D 5/02; C08F 220/18; C09J 7/30; C09J 7/50; C09J 7/25; B44C 1/17

(52) U.S. Cl. CPC C09D 133/12; C09D 5/002; C09D 5/022; C08F 220/18; C09J 7/30; C09D 175/04; C09J 7/255; B44C 1/1729; C09J 2201/61; C09J 2433/003; C09J 7/50

(57) ABSTRACT

The present invention is directed to a colloidal (meth)acrylic polymer emulsion, wherein the (meth)acrylic polymer has a weight average molecular weight of 3000 to 8000 daltons, Tg of 110 to 140° C. and an acid value of 150 to 240 mgKOH/g. The present invention also provide a water-based hot stamping primer coating which comprises the colloidal (meth)acrylic polymer emulsion. The present invention further provides a hot stamping film comprising a hot stamping primer formed from the water-based hot stamping primer coating.

### CROSS REFERENCE TO RELATED APPLICATIONS

This application claims priority to International Application No. PCT/CN2015/086227, filed Aug. 6, 2015, the entire contents of which are incorporated herein by reference in its entirety.

### FIELD OF THE INVENTION

The invention relates to a colloidal (meth)acrylic polymer emulsion and its application in water-based hot stamping primer coating and a method for preparing the same as well as a hot stamping film comprising a hot stamping primer formed from the water-based hot stamping primer coating.

### DESCRIPTION OF RELATED ARTS

Hot stamping primers are well known in the art of packaging for cigarette, liquor, food, and cosmetic etc. The hot stamping process for producing an aluminized packaging material in prior art comprises the steps of 1) applying a release layer onto the surface of substrate film (for example polyester film); 2) applying a solvent borne primer onto the release layer; 3) metalizing the aluminum on the top of the solvent borne primer; and 4) applying a hot melt adhesive on the top of the metalized aluminum.

CN103465668 discloses a hot stamping metalizing aluminum foil composed of a base film layer, a release layer, a color coating layer, a vacuum aluminum coated layer and a gumming layer, the color coating layer is prepared by mixing the following materials: 10 to 20 parts of carboxyl acrylic resin, 5 to 15 parts of cellulose acetate-nitrate, 1 to 10 parts of polyurethane, 1 to 10 parts of isocyanate, 1 to 5 parts of polyvinyl butyral, 1 to 5 parts of dye, 30 to 70 parts of butanone, 20 to 50 parts of ethyl acetate, 1 to 5 parts of propyl acetate.

Currently, hot stamping primers used in the hot stamping process are mainly organic solvent-based systems. Organic solvent used can be ethyl acetate, propyl acetate, butyl acetate, ketones, etc. Weight ratio of organic solvent in the primers can be 75-80%. As there is much organic solvent in the organic solvent-based hot stamping primers, which causes two significant defects: 1) much organic solvent evaporates during the printing process, which results in strong odor in the printing workshop and thus has negative influence on the environment; and 2) the evaporated organic solvent is highly flammable and the safety on the site is a problem, thus much safety investments are needed to ensure the safety on the site.

Therefore, there is a need to develop a water-based hot stamping primer coating which has excellent environment-friendly effect and can be used to form a packing material with good mirror aspect, good leveling property and high image resolution.

### SUMMARY OF THE INVENTION

For the purpose of the present invention, a colloidal (meth)acrylic polymer emulsion is provided, wherein the (meth)acrylic polymer has a weight average molecular weight of 3000 to 8000 daltons, a glass transition temperature (Tg) of 110 to 140° C. and an acid value of 150 to 240 mgKOH/g.

The present invention also provides a method for preparing the colloidal emulsion, which comprises

1) emulsifying the monomers for forming the (meth)acrylic polymer in water in the presence of surfactant to obtain a pre-emulsion; and

2) subjecting the pre-emulsion to free radical polymerization to obtain the colloidal (meth)acrylic polymer emulsion.

The present invention further provides a water-based hot stamping primer coating which comprises a colloidal (meth)acrylic polymer emulsion according to the present invention.

The present invention also provides a method for preparing the water-based hot stamping primer coating, which comprises

1) emulsifying the monomers for forming the (meth)acrylic polymer in water in the presence of surfactant to obtain a pre-emulsion;

2) subjecting the pre-emulsion to free radical polymerization to obtain a colloidal (meth)acrylic polymer emulsion;

3) neutralizing the colloidal (meth)acrylic polymer emulsion, and

4) optionally adding at least one additive selected from surfactant, coalescent agent, defoamer, wetting agent and wax.

The present invention also provides a hot stamping film which comprises a hot stamping primer formed from the water-based hot stamping primer coating according to the present invention.

### DESCRIPTION OF DRAWING

FIG. 1 shows a photograph according to comparative example 6.

FIG. 2 shows a photograph according to comparative example 7.

FIG. 3 shows a photograph according to comparative example 8.

FIG. 4 shows a photograph according to comparative example 9.

FIG. 5 shows a photograph according to comparative example 10.

FIG. 6 shows a photograph according to examples 5 and 6.

FIG. 7 shows a photograph according to examples 7 and 8 according to the present invention.

FIG. 8 shows a photograph obtained by using standard solvent-based hot stamping primer (comparative example 11).

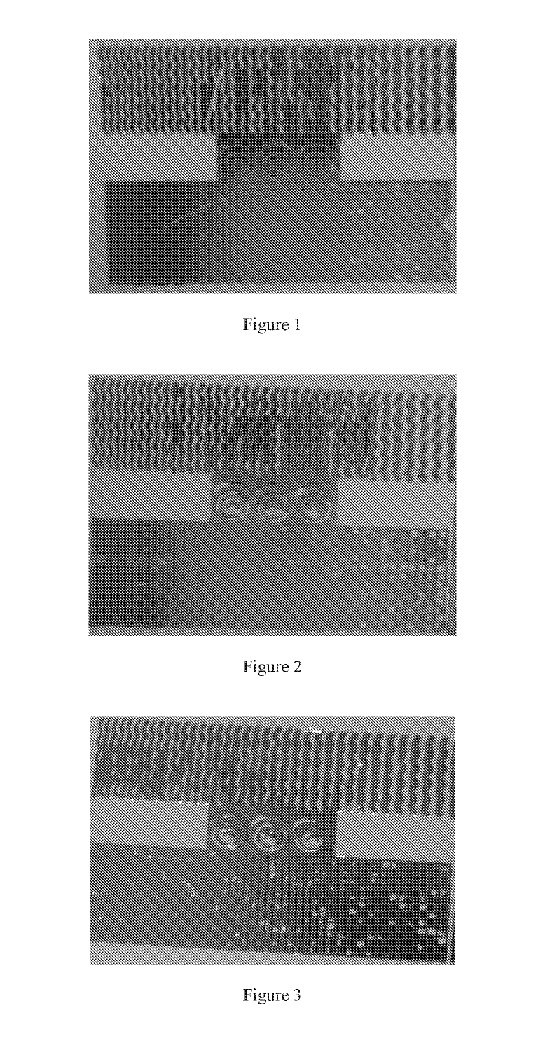

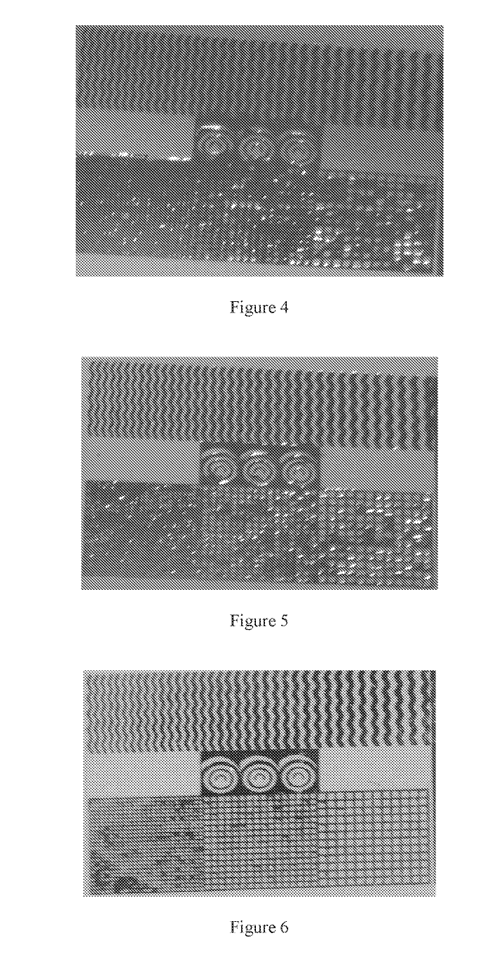

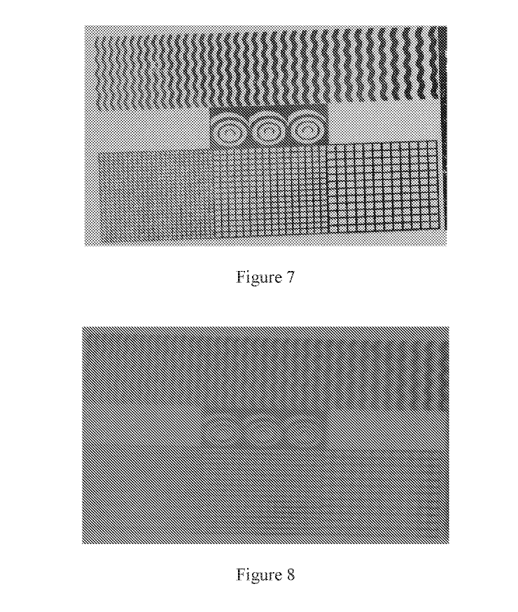

### EMBODIMENTS OF THE INVENTION

In one embodiment of the present invention, the present invention provides a colloidal (meth)acrylic polymer emulsion, wherein the (meth)acrylic polymer has a weight average molecular weight of 3000 to 8000 daltons, Tg of 110 to 140° C. and an acid value of 150 to 240 mgKOH/g.

The suitable (meth)acrylic polymer can be derived from (meth)acrylic acid and at least one monomer selected from the group consisting of C₁-C₈ alkyl (meth)acrylate, C₁-C₈ hydroxylalkyl (meth)acrylate and C₃-C₁₂ cycloalkyl (meth)acrylate.

Examples of C₁-C₈ alkyl (meth)acrylate can comprise methyl (meth)acrylate, ethyl (meth)acrylate, n-propyl (meth)acrylate, isopropyl (meth)acrylate n-butyl (meth)acrylate, isobutyl (meth)acrylate, pentyl (meth)acrylate, hexyl (meth)acrylate and 2-ethylhexyl (meth)acrylate etc, preferably methyl methacrylate, ethyl methacrylate, methyl acrylate and ethyl acrylate.

Examples of C₁-C₈ hydroxylalkyl (meth)acrylate can comprise hydroxymethyl (meth)acrylate hydroxyethyl (meth)acrylate, hydroxypropyl (metha)crylate and hydroxybutyl (metha)crylate etc.

Examples of C₃-C₁₂ cycloalkyl (meth)acrylate can comprise isobornyl (meth)acrylate and cyclohexyl (meth)acrylate.

In one preferred embodiment, the (meth)acrylic polymer has a weight average molecular weight of 4000 to 6000 daltons.

In another preferred embodiment, the (meth)acrylic polymer has Tg of 115 to 130° C., preferably 120 to 130° C. Tg is calculated according to Fox Equation:

1/Tg_{(Polymer)}=Wt %₁/Tg₁+Wt %₂/Tg₂+ . . . +Wt %ₙ/Tgₙ

Wt %ₙ is the weight content of each monomer based on total monomer, Tgₙ is the Tg of homopolymer of corresponding monomer (all temperatures used in the Fox Equation are expressed in degree K).

The Tg of homopolymers may be found, for example, in “Polymer Handbook”, edited by J. Brandrup and E. H. Immergut, Interscience Publishers.

The acid value of the (meth)acrylic polymer has a strong impact on the stability of the colloidal emulsion. If the acid value is too high, it is difficult to make the stable emulsion polymerization in the process. If the acid value is too low, it is difficult to achieve a nice solution after neutralization, hence the image quality and surface aspect after coating onto the substrate film is poor. In another preferred embodiment, the (meth)acrylic polymer has an acid value of 160 to 220 mgKOH/g, preferably 180 to 210 mgKOH/g.

In one embodiment, the present invention provides a method for preparing the colloidal emulsion according to the present invention, which comprises

1) emulsifying the monomers for forming the (meth)acrylic polymer in water in the presence of surfactant to obtain a pre-emulsion; and

2) subjecting the pre-emulsion to free radical polymerization to obtain the colloidal (meth)acrylic polymer emulsion.

The surfactant can be alkyl sulfate, alkyl-acryl sulfonate, alkyl ether sulfates, alkylphenol ether sulfates, sulfosuccinate, sulfossuccinamate, phosphoric acid esters, fatty alcohol ethoxylate, modified fatty alcohol ethoxylate, alkylphenol ethoxylate, alkyl polyglycolether, alkyl polyglycosides, EO/PO block copolymers, etc. The surfactant can be used singly or in a combination of two or more surfactants. Typical surfactant can be but not limited to Disponil FES27 (fatty alcohol ether sulphate (2EO)), Disponil FES 77 (fatty alcohol ether sulphate (30EO)), Disponil SUS 875 Special (sulfosuccinate), Disponil AES 60 (alkylphenol ethersulfates), Disponil AES 25 (alkylphenol ethersulfates), Disponil FEP 6300, Disponil SDS30, Disponil SLS 103 (Sodium Dodecyl Sulfate), Disponil LDBS 23 (sodium dodecyl benzene sulfonate), Disponil DB 45 (Sodium Lauryl Diphenyl Ether Disulfonate), Disponil AFEX 3070 (fatty alcohol ether phosphate), Disponil TA 400 (fatty alcohol ethoxylate, 30EO), Lutensol AT 11 to AT 25 (C16-C18 Fatty alcohol ethoxylates), Lutensol TO 8 to TO 15 (C13 Oxo alcohol ethoxylates), Lutensol TO 4070, Emulan TO 2080 to TO 4070 (C13 Oxo alcohol ethoxylate) etc. available from BASF. The surfactant can be used either individually or else in a mixture with one another.

The free radical polymerization of pre-emulsion is carried out in a manner known per se. For example, the pre-emulsion can be heated to a temperature in the range from 20 to 150° C., preferably from 40 to 90° C., and then a free radical polymerization initiator, for example peroxo compound is added.

Chain transfer agent can also be added to control the molecular weight of the polymer. Typical chain transfer agent comprises: 1) thiols, such as: dodecyl mercaptane, t-dodecyl mercaptane, 3-mercaptopropionic acid, 2-ethylhexyl thioglycolate, terpinnolene, butyl 3-mercaptopropanoate and similar chemical homologues; 2) halocarbons, such as: carbon tetrachloride and similar chemical homologues; and 3) alcohols, such as iso-propanol, iso-butanol and similar chemical homologues.

The amount of chain transfer agent is depending on the desired molecular weight of the polymer. The higher amount of the chain transfer agent is, the lower molecular weight of the resulted polymer will be. Usually, the content of chain transfer agent is less than 8 wt % based on the total weight of the monomers, preferably less than 6 wt %, for example from 2 wt % to 6 wt %.

In one embodiment, the present invention provides a water-based hot stamping primer coating which comprises a colloidal (meth)acrylic polymer emulsion according to the present invention, wherein the colloidal (meth)acrylic polymer emulsion is in neutralized form.

According to the present invention, the water-based hot stamping primer coating can further comprises at least one additive selected from surfactant, coalescent agent, defoamer, wetting agent and wax.

In one embodiment, the present invention provides a method for preparing the water-based hot stamping primer coating according to the present invention, which comprises

1) emulsifying the monomers for forming the (meth)acrylic polymer in water in the presence of surfactant to obtain a pre-emulsion;

2) subjecting the pre-emulsion to free radical polymerization to obtain a colloidal (meth)acrylic polymer emulsion;

3) neutralizing the colloidal (meth)acrylic polymer emulsion, and

4) optionally adding at least one additive selected from surfactant, coalescent agent, defoamer, wetting agent and wax.

Suitable surfactant and chain transfer agent are those as mentioned above.

The neutralization in step 3) can be carried out by using at least one neutralizing agent selected from hydroxide of alkali metal, or ammonia. Neutralizing agents used are, for example, sodium hydroxide, potassium hydroxide, and ammonia.

In one embodiment, the present invention provides a hot stamping film which comprises a hot stamping primer formed from the water-based hot stamping primer coating according to the present invention. For example, the hot stamping film can comprise a base film, a release layer, a hot stamping primer formed from the water-based hot stamping primer coating according to the present invention, a metalizing aluminum layer and a hot melt adhesive layer.

The hot stamping film according to the present invention can be obtained by the following step:

1) applying a release layer onto the surface of a base film (for example polyester film);

2) applying the water-based hot stamping primer coating according to the present invention onto the release layer to obtain a hot stamping primer;

3) metalizing the aluminum on the top of the water-based hot stamping primer; and

4) applying a hot melt adhesive on the top of the metalized aluminum to obtain the hot stamping film.

In one embodiment, the present invention provides a packaging material which comprises a hot stamping primer formed from the water-based hot stamping primer coating according to the present invention. The packing material can be obtained by hot stamping the hot stamping film according to the present invention on a substrate (for example paper, paper board, plastic sheet including acrylonitrile-butadiene-styrene copolymer or polycarbonate or paper packaging materials of cigarette, liquor, food, and cosmetic) and then peeling off the base film. For example, the hot stamping film can be hotstamped from base film side, the temperature of the hotstamp plate is about 100 to 120° C., the total duration is less than 1 second, then the image was transferred to the substrate by the hot melt adhesive. The final product (packaging material) is obtained by peeling off the base film.

The final product of hot stamping is a surface metalized substrate (for example paper packaging materials) with shining and mirror aspect, and this final product of hot stamping can be further used to package cigarette, alcohol, food, cosmetic, etc.

In one embodiment, the present invention provides the use of the water-based hot stamping primer coating according to the present invention for preparing the packaging materials of cigarette, liquor, food, and cosmetic. The present invention also provides a packaging material which comprises a hot stamping primer formed from the water-based hot stamping primer coating according to the present invention.

### EXAMPLES

The following examples illustrate the invention

All percentages are mentioned by weight unless otherwise indicated. In the examples, the following abbreviations are used:

MMA=methyl methacrylate

MAA=methacrylic acid

EA=ethyl acrylate

3-MA=3-mercaptopropionic acid

MBM=methoxy butyl 3-mercaptopropionate

TDM=t-dodecyl mercaptane

2-EHT=2-ethyl hexyl thioglycoate

The molecular weight (Mw) is measured by Gel Permeation Chromatography (GPC) with poly(acrylic acid)-Na salt as standards.

### Examples 1 to 4 and Comparative Examples 1 to 5: Preparing Neutralized Colloidal (Meth)acrylic Polymer Emulsion

Examples 1 to 4 and Comparative examples 1 to 5 were carried out under the same following procedure, except that different material and amount thereof as shown in table 1 are used in each example and comparative example.

In a 1000 ml four bottle-neck glass reactor with reflux, thermal couple and agitator equipped, 500 g of water, 0.25 g of surfactant A and 0.25 g of surfactant B were charged, then stirred till homogenous and heated to 80-85° C.

Meanwhile, 100 g of water was charged into an open glass vessel with agitator followed by adding 1.75 g surfactant A and 1.75 g surfactant B and stirring till homogenous. Then a mixture of monomers and chain transfer agent was charged into the open glass vessel gradually with stirring at 200 rpm and continuously stirring at 600 rpm for another 30 minutes to form the pre-emulsion.

When the temperature of four bottle-neck glass reactor reached 80° C., 15 g of 20% ammonium persulfate solution was added into the reactor by one shot. Then the pre-emulsion above was continuously added into the reactor within 240 minutes, while temperature was controlled at 80-90° C. After the pre-emulsion feed was added completely, the reaction was maintained at 80-90° C. for another 100 minutes. Then corresponding amount of 20% ammonia solution was added into the reactor to neutralize the emulsion at 70° C., the mixture was further stirred for 2 hours till homogeneous. The details of monomers and other additives of each Example and Comparative example are listed in below table 1. The weight average molecular weight (Mw), calculated Tg and acid value of the (meth)acrylic polymer are listed in below table 2.

TABLE 1
monomers, other additives and amount thereof used in Examples 1 to 4 and
Comparative examples 1 to 5:

| | MMA | MAA | EA | Chain | Ammonia | Surfactant | Surfactant |
|---|---|---|---|---|---|---|---|
| Example | (g) | (g) | (g) | transfer agent | solution (g) | A (g) | B (g) |
| Comparative | 120.6 | 96.8 | 82.5 | 1.5 g 3-MA | 95.7 | Disponil | Disponil |
| example 1 | | | | | | FES 27 | FES 77 |
| Comparative | 120.6 | 96.8 | 82.5 | 3 g MBM | 95.7 | Disponil | Lutensol |
| example 2 | | | | | | SLS103 | AT 18 |
| Comparative | 157.2 | 82.9 | 60.0 | 3 g 2-EHT | 81.9 | Disponil | Disponil |
| example 3 | | | | | | FES 77 | SDS 30 |
| Comparative | 207.0 | 69.1 | 24.0 | 3 g TDM | 68.3 | Disponil | Lutensol |
| example 4 | | | | | | LDBS 23 | TO 4070 |
| Comparative | 207.0 | 69.1 | 24.0 | 6 g 3-MA | 68.3 | Disponil | Disponil |
| example 5 | | | | | | DB 45 | FES 27 |
| Example 1 | 205.2 | 82.9 | 12.0 | 6 g 2-EHT | 81.9 | Disponil | Lutensol |
| | | | | | | LDBS 23 | to 4070 |
| Example 2 | 217.2 | 82.9 | | 12 g 2-EHT | 81.9 | Disponil | Lutensol |
| | | | | | | LDBS 23 | AT 18 |
| Example 3 | 217.2 | 82.9 | | 18 g 3-MA | 81.9 | Disponil | Disponil |
| | | | | | | FES 77 | LDBS 23 |
| Example 4 | 198.0 | 96.1 | 5.1 | 18 g 3-MA | 95.7 | Disponil | Disponil |
| | | | | | | FES 77 | LDBS 23 |

### Example 5

68 g of the neutralized colloidal (meth)acrylic polymer emulsion obtained from example 1 was put into a 300 ml polyethylene cup. 16 g water and 16 g isopropanol were charged into the cup under agitation at 400 rpm in order to mix until homogeneous, finally a clear transparent liquid was formed.

The resulted liquid was applied by 12 μm bar coater onto the PET film, of which PET film was pre-coated with commercially available water-based wax, and then put into oven to dry for 2 min at 50° C. The coated and dried film was metalized with Al for 60-100 nm thickness in the metallization chamber at 10⁻⁵ vacuum degree.

The commercially available polyurethane-based hot melt adhesive was then coated by 12 μm bar coater onto the Al side. Then a hot stamping film was obtained.

The hot stamping film was hot stamped from PET film side for less than 1 second, the temperature of the hot stamp plate was about 100-120° C., then the image was transferred to paper board by hot melt adhesive. The final aluminized packaging material was obtained by peeling of the PET film. The mirror aspect, levelling and image resolution of final aluminized packaging material were determined visually. The results are listed in table 2 below.

### Example 6

The procedure of Example 5 was repeated with the difference that a neutralized (meth)acrylic polymer emulsion obtained from example 2 is used. The results are listed in table 2 below.

### Example 7

The procedure of Example 5 was repeated with the difference that a neutralized (meth)acrylic polymer emulsion obtained from example 3 is used. The results are listed in table 2 below.

### Example 8

The procedure of Example 5 was repeated with the difference that a neutralized (meth)acrylic polymer emulsion obtained from example 4 is used. The results are listed in table 2 below.

### Comparative Examples 6 to 10

The procedure of Example 5 was repeated with the difference that neutralized (meth)acrylic polymer emulsions obtained from comparative examples 1 to 5 are used, respectively. The results are listed in table 2 below.

### Comparative Example 11

A standard solvent-based hot stamping primer (AC347-13 from Lubrizol Chemical) was applied by 12 μm bar coater onto the PET film, of which PET film was pre-coated with commercially available water-based wax, and then put into oven to dry for 2 min at 50° C. The coated and dried film was metalized with Al for 60-100 nm thickness in the metallization chamber at 10⁻⁵ vacuum degree.

The commercially available polyurethane-based hot melt adhesive was then coated by 12 μm bar coater onto the Al side. Then a hot stamping film was obtained.

The hot stamping film was hot stamped from PET film side for less than 1 second, the temperature of the hot stamp plate was about 100-120° C., then the image was transferred to paper board by hot melt adhesive. The final aluminized packaging material was obtained by peeling off the PET film. The photograph of resulted final aluminized packaging material is shown in FIG. 8.

TABLE 2
Mw, acid value and Tg of the (meth)acrylic polymers used in examples 5 to 8 and
comparative examples 6 to 10 and the results of examples 5 to 8 and
comparative examples 6 to 10

| | Mw | Acid value¹ | | | | Image |
|---|---|---|---|---|---|---|
| Example | (Daltons) | (mg KOH/g) | Tg (° C.) | Mirror aspect | Levelling | resolution |
| Comparative | 20000 | 210 | 75 | ● | ●●●●● | ● |
| example 6 | | | | | | |
| Comparative | 12000 | 210 | 75 | ● | ●●●●● | ●● |
| example 7 | | | | | | |
| Comparative | 12000 | 180 | 85 | ●● | ●●●●● | ●● |
| example 8 | | | | | | |
| Comparative | 12000 | 150 | 106 | ●●● | ●●●●● | ●●● |
| example 9 | | | | | | |
| Comparative | 8000 | 150 | 106 | ●●● | ●●●●● | ●●●● |
| example 10 | | | | | | |
| Example 5 | 8000 | 180 | 116 | ●●●● | ●●●●● | ●●●● |
| Example 6 | 6000 | 180 | 124 | ●●●● | ●●●●● | ●●●● |
| Example 7 | 4000 | 180 | 124 | ●●●●● | ●●●●● | ●●●●● |
| Example 8 | 4000 | 210 | 124 | ●●●●● | ●●●●● | ●●●●● |

Remarks: ●●●● or above indicates the results acceptable in the industry, while ●●● or below indicates the results non acceptable in the industry; mirror aspect of Comparative example 6 is ●, while mirror aspect of Example 7 is ●●●●●, image resolution of Comparative example 6 is ●, while image resolution of Example 7 is ●●●●●
¹Acid value of the (meth)acrylic polymer is calculated as follows: there are X gram of acidic material A with single —COOH in its molecule in total Y gram monomers, and acid value of material A can be calculated by 1000 * 56.1/(molecular weight of A), then the acid value of the (meth)acrylic polymer can be got by following equation: Acid value = X * (acid value of A)/Y, the unit is “mgKOH/g”, wherein Y means the weight of total monomers.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A colloidal (meth)acrylic polymer emulsion, wherein the (meth)acrylic polymer has a weight average molecular weight of 3000 to 8000 Daltons, a Tg of 110 to 140° C. and an acid value of 150 to 240 mg KOH/g.

2. The colloidal (meth)acrylic polymer emulsion of claim 1, wherein the (meth)acrylic polymer has a weight average molecular weight of 4000 to 6000 Daltons.

3. The colloidal (meth)acrylic polymer emulsion of claim 1, wherein the (meth)acrylic polymer has Tg of 115 to 130° C.

4. The colloidal (meth)acrylic polymer emulsion of claim 1, wherein the (meth)acrylic polymer has an acid value of 160 to 220 mg KOH/g.

5. The colloidal (meth)acrylic polymer emulsion of claim 1, wherein the (meth)acrylic polymer comprising the polymerization product of (meth)acrylic acid and at least one monomer selected from the group consisting of C₁-C₈ alkyl (meth)acrylate, C₁-C₈ hydroxylalkyl (meth)acrylate, and C₃-C₁₂ cycloalkyl (meth)acrylate.

6. The colloidal (meth)acrylic polymer emulsion of claim 5, wherein the C₁-C₈ alkyl (meth)acrylate is selected from methyl (meth)acrylate, ethyl (meth)acrylate, n-propyl (meth)acrylate, isopropyl (meth)acrylate n-butyl (meth)acrylate, isobutyl (meth)acrylate, pentyl (meth)acrylate, hexyl (meth)acrylate, and 2-ethylhexyl (meth)acrylate.

7. The colloidal (meth)acrylic polymer emulsion of claim 5, wherein the C₁-C₈ hydroxylalkyl (meth)acrylate is selected from hydroxymethyl (meth)acrylate hydroxyethyl (meth)acrylate, hydroxypropyl (metha)crylate and hydroxybutyl (metha)crylate.

8. The colloidal (meth)acrylic polymer emulsion of claim 5, wherein the C₃-C₁₂ cycloalkyl (meth)acrylate is selected from isobornyl (meth)acrylate, and cyclohexyl (meth)acrylate.

9. A method for preparing a colloidal (meth)acrylic polymer emulsion, wherein the (meth)acrylic polymer has a weight average molecular weight of 3000 to 8000 Daltons, a Tg of 110 to 140° C. and an acid value of 150 to 240 mgKOH/g, the method comprising:
emulsifying monomers for forming the (meth)acrylic polymer in water in the presence of a surfactant to obtain a pre-emulsion; and
subjecting the pre-emulsion to free radical polymerization to obtain the colloidal (meth)acrylic polymer emulsion.

10. The method of claim 9, wherein the surfactant is selected from the group consisting of alkyl sulfates, alkyl-acryl sulfonates, alkyl ether sulfates, alkylphenol ether sulfates, sulfosuccinates, sulfossuccinamates, phosphoric acid esters, fatty alcohol ethoxylates, modified fatty alcohol ethoxylates, alkylphenol ethoxylates, alkyl polyglycolethers, alkyl polyglycosides, EO/PO block copolymers, and mixtures of any two or more thereof.

11. A water-based hot stamping primer coating which comprises a colloidal (meth)acrylic polymer emulsion of claim 1, wherein the colloidal (meth)acrylic polymer emulsion is in neutralized form.

12. The water-based hot stamping primer coating of claim 11, which further comprises at least one additive selected from surfactant, coalescent agent, defoamer, wetting agent and wax.

13. A method for preparing the water-based hot stamping primer coating of claim 11, the method comprising:
emulsifying monomers for forming the (meth)acrylic polymer in water in the presence of a surfactant to obtain a pre-emulsion;
subjecting the pre-emulsion to free radical polymerization to obtain a colloidal (meth)acrylic polymer emulsion;
neutralizing the colloidal (meth)acrylic polymer emulsion; and
optionally adding at least one additive selected from the group consisting of surfactants, coalescent agents, defoamers, wetting agents and waxes.

14. The method of claim 13, wherein the surfactant is selected from alkyl sulfate, alkyl-acryl sulfonate, alkyl ethersulfates, alkylphenol ethersulfates, sulfosuccinate, sulfossuccinamate, phosphoric acid esters, fatty alcohol ethoxylate, modified fatty alcohol ethoxylate, alkylphenol ethoxylate, alkyl polyglycolether, alkyl polyglycosides, EO/PO block copolymers, and mixture thereof.

15. The method of claim 13, wherein the neutralizing is carried out by using at least one neutralizing agent selected from group consisting of an alkali metal hydroxide and an ammonium hydroxide.

16. A hot stamping film which comprises a hot stamping primer formed from the water-based hot stamping primer coating of claim 11.

17. The hot stamping film according to claim 16, wherein the hot stamping film comprises a base film, a release layer, a hot stamping primer formed from water-based hot stamping primer coating, a metalizing aluminum layer, and a hot melt adhesive layer.

18. A method for preparing the hot stamping film, the method comprising:
applying a release layer onto the surface of a base film;
applying the water-based hot stamping primer coating of claim 11 onto the release layer to obtain a hot stamping primer;
metalizing the aluminum on the top of the water-based hot stamping primer; and
applying a hot melt adhesive on the top of the metalized aluminum to obtain the hot stamping film.

19. A packaging material comprising the water-based hot stamping primer coating of claim 11, wherein the packaging material is a cigarette, liquor, food, or cosmetic packaging material.

20. A packaging material which comprises a hot stamping primer formed from the water-based hot stamping primer coating of claim 11.
